(19) United States
(12) Patent Application Publication
(10) Pub. No.: US 2012/0261461 A1
(43) Pub. Date: Oct. 18, 2012

(54) MULTI-UP BUSINESS ENVELOPE FOR DIGITAL PRINTING

(75) Inventors: Liam S. Cummings, Macedon, NY (US); Robert L. Dengler, Webster, NY (US); John M. Viavattine, Rochester, NY (US); Paul C. Smith, Webster, NY (US); Arthur A. Padilla, East Rochester, NY (US); David S. Cody, Webster, NY (US); Marc Wetmore, Rochester, NY (US)

(73) Assignee: XEROX CORPORATION, Norwalk, CT (US)

(21) Appl. No.: 13/087,409

(22) Filed: Apr. 15, 2011

(51) Int. Cl. B65D 27/00; B31B 19/00

(52) U.S. Cl. 229/75; 493/220; 493/228; 493/243; 493/264

(57) ABSTRACT

Two sheets of 20# paper of 21″×10⅛″ sheet size are laminated together using pattern printed adhesive and silicon sites to create a sheet of multi-up #10 envelopes. Each envelope is separated by a perforation in the sheet and includes edges that are square folded to eliminate image deletions as the envelopes travel through a printer. Three kiss slits are located at the bottom of each envelope to allow air to escape and prevent wrinkling as they are conveyed through a printer. The flaps for each of the envelopes are included in the sheet which are to be folded over and sealed using a peel and seal adhesive strip, which keeps the strip moisture free and the flap opened to eliminate issues of sealing in the printer.

### BACKGROUND

1. Field of the Disclosure

This invention relates to envelope construction, and more particularly, to a multi-up envelope construction arrangement useful for receiving images from digital printing machines without transfer deletion occurring.

2. Description of Related Art

The ability to print variable data with digital printers has enticed customers to use that capability to print a series of addresses on envelopes and use the envelopes as tools for messaging and target selling. However, business envelopes have been difficult to run in digital printers for a variety of reasons; such as, jamming, wrinkling, issues with adhesives setting up due to moisture (fuser oil) and/or heat and pressure from the fusing process. The typical design of most of these envelopes adds a multi-ply layer seam within the body of the envelope, which consequently creates a transfer deletion on the address portion of the face of the envelope when imaged through a printer. For machines sensitive to a limited loading stack it becomes an inefficient way to use the printer with limited confidence of successful output. There are designs that account for some of the problems and seasoned operators can alleviate others, but productive and efficient run lengths are not to be expected, particularly with production scaled equipment.

Typical prior art envelopes in use are of the type disclosed in U.S. Pat. Nos. 914,274; 3,666,926; and 4,004,728, which either disclose envelopes having three or more overlapped layers, such as, U.S. Pat. Nos. 3,627,195 and 4,004,728, or are of two layer materials, but are not suited or configured to be utilized with copier sheet feeding operations, such as, the envelopes disclosed in U.S. Pat. Nos. 914,274 and 3,666,926. Envelopes which have portions of three or more overlapped layers of material are affected when passing through the toner image fixing apparatus of the type having a heated roller and a back up pressure roller. In this type of fixing apparatus, the rollers are spaced apart to handle a predetermined range of paper thicknesses in order to insure quality fixing. While two thicknesses of sheets may sometimes be tolerated, three thicknesses have, in practice, resulted in deterioration in quality, smudging of toner images, and physical damage, such as, wrinkling on those portions of the envelope whereat three layers of paper are present.

Thus, there is still a need for an envelope configuration that will feed through a high speed printer without wrinkling or experiencing image transfer deletion.

### BRIEF SUMMARY OF THE DISCLOSURE

Accordingly, in answer to this need, provided hereinafter is a multi-up envelope configuration that is applicable over a wide range of sizes and capabilities. In one embodiment, a business envelope (#10) is used in a 21″×10⅛″ sheet size, which fits into an extra large tray size of a printer. Essentially, two sheets of 20# paper of 21″×10⅛″ sheet size are laminated together using pattern printed adhesive and silicon sites to create a sheet of multi-up #10 envelopes. Each envelope is surrounded by a perforation in the sheet and that can be trimmed after printing. Edges are square folded to eliminate the multi-ply design that causes image deletions. There are 3 kiss slits at the bottom of each envelope to allow air escape and prevent wrinkling in the printer. Flaps for each of the envelopes are included in the sheet which can be folded over and sealed by the customer using a peel and seal adhesive strip, which keeps the strip moisture free and the flap opened to eliminate issues of sealing in the printer.

### BRIEF DESCRIPTION OF THE DRAWINGS

Various of the above-mentioned and further features and advantages will be apparent to those skilled in the art from the specific apparatus and its operation or methods described in the example(s) below, and the claims. Thus, they will be better understood from this description of these specific embodiment(s), including the drawing figures (which are approximately to scale) wherein:

FIG. 1 is a plan view of the bottom sheet of a multi-up two-ply envelope configuration that includes four envelopes; and

FIG. 2 is a plan view of a top sheet that mates with the bottom sheet of FIG. 1 to form the four two-ply envelopes.

### DETAILED DESCRIPTION OF THE PREFERRED EMBODIMENT

While the disclosure will be described hereinafter in connection with a preferred embodiment thereof, it will be understood that limiting the disclosure to that embodiment is not intended. On the contrary, it is intended to cover all alternatives, modifications and equivalents as may be included within the spirit and scope of the disclosure as defined by the appended claims.

The disclosure will now be described by reference to a preferred embodiment that includes a method for making multiple two-ply envelopes from a sandwich of two sheets of paper.

For a general understanding of the features of the disclosure, reference is made to the drawings. In the drawings, like reference numerals have been used throughout to identify identical elements.

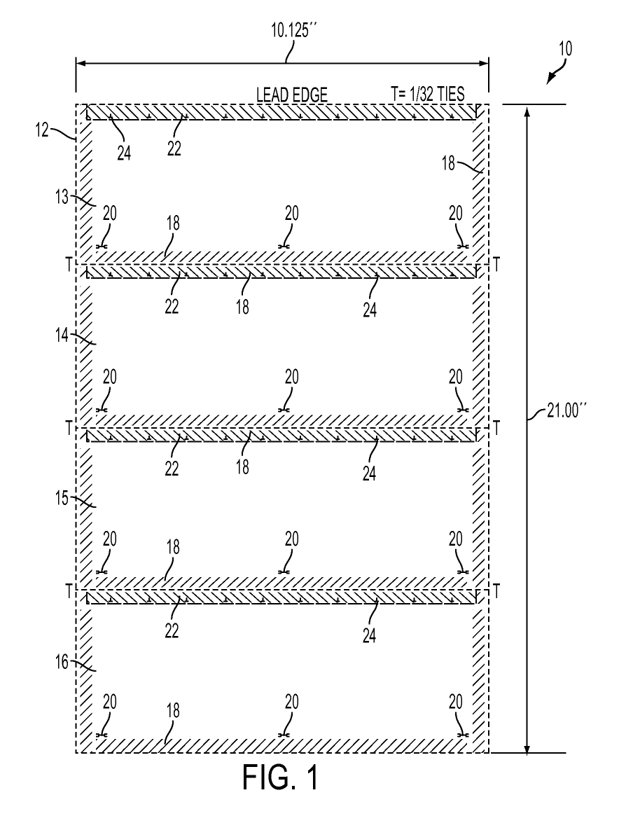

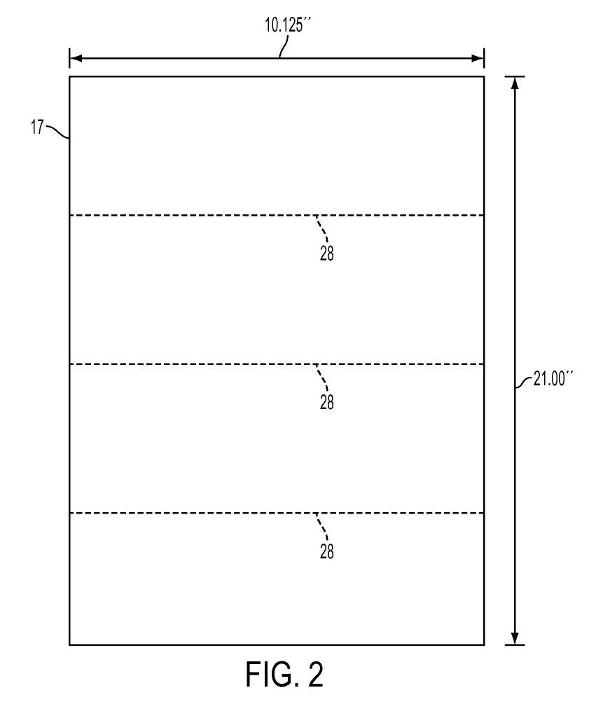

Referring now to FIGS. 1 and 2, a method for creating uniform thickness envelopes which run through printers more smoothly than existing options is disclosed that comprises the multi-up envelope configuration 10 which includes a bottom sheet 12 is shown having a width of 10.125 inches and length of 21.00 inches represented by dotted lines and includes the back portions of four individual envelopes 13, 14, 15 and 16. The lead edge of sheet 12 is at the top of the sheet as viewed in FIG. 1 or the top edge of envelope 13. The envelope backs are separated by 1/32″ ties or perforations across their top portions at locations marked by a “T” which can be trimmed after printing. The top portions of the envelopes are square folded to eliminate the multi-ply configuration that causes image deletions. There are three kiss slits 20 at the bottom of each envelope to allow air to escape and prevent wrinkling in a printer. Additionally, air vents are included on either side of the bottom portion of envelope 16 to prevent air entrapment which leads to wrinkles caused by the fuser of a printer.

An adhesive 18 is included in predetermined areas of bottom sheet 12 for adhering portions of the bottom sheet together with portions of top sheet 17 shown in FIG. 2 to form a two-ply sandwich configuration and thereby form four substantially sealed envelopes. The two sheets 12 and 17 are laminated together using the pattern printed adhesive 18 and silicon sites to create the sheet of multi-ply envelopes. Top sheet 17 has perforations 28 therein to facilitate separation of each envelope from the sandwich configuration. The adhesive 18 is recessed 1/16″ from the side and top edges of the sheet to prevent contamination from the fuser of a printer. In addition, 1/16″ adhesive voids are included between the envelopes for separation purposes. Flaps 22 are included for each of the envelopes in sheet 12 which can be folded over and sealed by a customer using a conventional peel and seal adhesive strip, which keeps the strip moisture free and the flap opened to eliminate issues of sealing in the printer. Pencil perforations 24 placed along the bottom portion of the top flap of envelope 13 at predetermined distances apart are made after the two sheets 12 and 17 are laminated. These are created to provide an access to the opening in the fully assembled envelope. The individual envelopes can be separated manually, by machine bursting or by guillotine.

Alternatively, and because the disclosed method for creating envelopes is a multi-up sequence, it is not limited to the disclosed configuration of four-up, and can be reduced down to a 10.125 inch×10.5 inch two-up, or expanded to a full roll capability for continuous feed devices, if desired.

An advantage of the heretofore described method of creating multi-up, multi-ply envelopes is in facilitating customization options for customers and thereby giving the customers the ability to print high quality variable data with digital printers on a series of envelopes and use the envelopes as a tool for messaging and target selling. In addition, customer productivity is increased with multi-up applications and customer satisfaction is increased with less machine shutdowns and better print quality.

In recapitulation, two sheets of 20# paper of 21″×10⅛″ sheet size are laminated together using pattern printed adhesive and silicon sites to create a sheet of multi-up #10 envelopes. Each envelope is separated by a perforation in the sheet and includes edges that are square folded to eliminate image deletions. Three kiss slits are located at the bottom of each envelope to allow air to escape and prevent wrinkling as they are conveyed through a printer. The flaps for each of the envelopes are included in the sheet which can be folded over and sealed by the customer using a peel and seal adhesive strip, which keeps the strip moisture free and the flap opened to eliminate issues of sealing in the printer.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others. Unless specifically recited in a claim, steps or components of claims should not be implied or imported from the specification or any other claims as to any particular order, number, position, size, shape, angle, color, or material.

What is claimed is:

1. A method for creating uniform thickness envelopes that will run through printers without transfer deletions, comprising:
providing a first sheet and a second sheet that mate to form multiple two-ply envelopes, said first sheet including multiple rectangular shaped patterns of adhesive substantially surrounding a back portion of multiple envelopes therein for securing said first and second sheets together, said adhesive being absent from void areas that separate top portions of each of said multiple back portions of said multiple two-ply envelopes, said void areas including perforations therethrough in order to facilitate separation of said multiple back portions from said first sheet;
providing said first sheet with air vents on opposite sides of a bottom portion of each of said multiple envelope back portions;
providing said second sheet with perforations that complement said perforations of said first sheet, and
mating said first sheet with said second sheet to form said multiple two-ply envelopes.

2. The method of claim 1, wherein said adhesive void areas have a width of about 1/16″.

3. The method of claim 1, separating said envelopes by bursting said perforations.

4. The method of claim 1, including recessing said adhesive by about 1/16″ away from edges of said first sheet.

5. The method of claim 1, wherein each of said multiple two-ply envelopes have edges that are square folded to eliminate image deletion when printing thereon.

6. The method of claim 1, including providing slits at the bottom of each envelope to allow air to escape and thereby prevent wrinkling as they are fed through a printer.

7. The method of claim 6, including providing three slits at the bottom of each envelope.

8. The method of claim 1, wherein flaps for each envelope are included in said first sheet.

9. The method of claim 8, wherein said flaps include a peel and seal adhesive strip that keeps said strip moisture free and said flap opened to eliminate sealing when fed through a printer.

10. The method of claim 1, wherein said first sheet includes four back portions of envelopes.

11. A multi-up envelope construction arrangement useful for receiving images from digital printing machines without transfer deletion occurring, comprising:
a first sheet of a predetermined size, said first sheet including multiple rectangular shaped pattern printed adhesives substantially surrounding a back portion of multiple envelopes configured therein, said pattern printed adhesives being absent from void areas that separate top portions of each of said back portions of said multiple envelopes, said void areas including perforations therethrough in order to facilitate separation of said back portions of said multiple envelopes from said first sheet, and wherein each of said back portions of said multiple envelopes includes air vents on opposite sides of a bottom portion thereof; and
a second sheet with perforations therein that complement said perforations of said first sheet, said second sheet being adapted through said pattern printed adhesives to mate said first sheet to form multiple two-ply envelopes.

12. The multi-up envelope construction arrangement of claim 11, wherein each of said back portions of said multiple envelopes configured in said first sheet includes a peel and stick flap closure portion that is opened and flat during feeding through a printer.

13. The multi-up envelope construction arrangement of claim 11, wherein at least three air vents are included in said bottom portion of said back portions of said multiple envelopes configured in said first sheet.

14. The multi-up envelope construction arrangement of claim 11, including recessing said pattern printed adhesives by about 1/16″ away from edges of said first sheet.

15. The multi-up envelope construction arrangement of claim 12, wherein said flap closure portions of each of said multiple two-ply envelopes have edges that are adapted to be square folded to eliminate image deletion when printing thereon.

16. The multi-up envelope construction arrangement of claim 1, including pencil perforations placed along a bottom portion of a top portion of each of said flap closure portions after said first and second sheets have been laminated in order to provide an access to openings in the fully assembled envelopes.

17. A multiple envelope configuration for processing through a digital printer, comprising: a first sheet with a series of rectangular shaped envelope backs for envelopes configured thereon; pattern printed adhesives surrounding a major portion of each of said series of envelope backs, and wherein said pattern printed adhesives are recessed a predetermined amount from edges of said first sheet to prevent contamination from a fuser during digital printing and to created adhesive void areas for clean separation of individual envelopes; strategically placed air vents to prevent air entrapment and fuser wrinkles on said individual envelopes during digital printing; closure flaps connected to each of said series of envelope backs adapted to lay-open and flat during digital printing; and a second sheet adapted to be adhered to said first sheet and provide a series of front covers for said series of envelope backs and thereby provide a series of individual envelopes.

18. The multi-up envelope construction arrangement of claim 11, wherein said first sheet includes four back portions of envelopes.

19. The multi-up envelope construction arrangement of claim 18, wherein each of said four back portions of envelopes includes a flap having a peel and seal adhesive strip that keeps said adhesive strip moisture free and said flap opened to eliminate sealing when fed through a printer.

20. The of multi-up envelope construction arrangement claim 11, including kiss slits along said bottom portion of said back portions of said multiple envelopes configured in said first sheet.
